(19) United States
(12) Patent Application Publication
(10) Pub. No.: US 2025/0258462 A1
(43) Pub. Date: Aug. 14, 2025

(54) Method and system for aligning local and astronomical time in celestial clocks

(71) Applicant: Charles A. G. Gugino, Las Vegas, NV (US)

(72) Inventor: Charles A. G. Gugino, Las Vegas, NV (US)

(21) Appl. No.: 19/011,394

(22) Filed: Jan. 6, 2025

Related U.S. Application Data
(60) Provisional application No. 63/618,339, filed on Jan. 7, 2024.

(51) Int. Cl. G04B 19/22; G04B 19/04

(52) U.S. Cl. CPC G04B 19/22; G04B 19/048

(57) ABSTRACT

The present invention is a digital timekeeping system that integrates standard civil time with real-time astronomical data, including sunrise, sunset, moonrise, moonset. Utilizing ephemeris calculations, the system dynamically adjusts a 360° clockface to reflect varying day and night lengths based on the user's geographic location and date. Sunrise is anchored at left and sunset at right, dividing the clockface into equal and distinct daytime and nighttime arcs. Hour indices are proportionally spaced to represent actual daylight and darkness durations, creating intuitive time visualization. Sun and moon indicators traverse the dial, positioning themselves in the upper semicircle when above the horizon and in the lower semicircle when below. This solution adapts to diverse geographic conditions, including polar regions, providing an intuitive representation of celestial movements alongside conventional timekeeping. The invention uniquely aligns standard time with celestial observations, offering users a precise visual depiction of time integrated with natural astronomical cycles.

### CROSS-REFERENCE TO RELATED APPLICATIONS

This application references and incorporates by reference U.S. Design Patent Application No. 29/907,490, titled “Clock with Day-Night Variation,” filed on Jan. 7, 2024, in its entirety.

This application is a non-provisional filing of and claims the benefit of U.S. Provisional Patent Application No. 63/618,339, filed on Jan. 7, 2024, the entirety of which is also incorporated by reference herein.

### PRIOR ART

Applicant is aware of references and inventions that addressed partial or approximate day/night indicators, yet did not fully resolve the dynamic and location-specific distribution of hour indices or integrate a comprehensive solar-lunar display in a single 360° dial. Notable examples include:

U.S. Pat. No. 1,807,497A: This patent disclosed a day/night clock concept employing a partially divided dial. However, it relied on fixed anchoring of day and night to predetermined times (6:00 AM for sunrise and 6:00 PM for sunset) rather than dynamically recalculating sunrise and sunset based on real ephemeris data. As a result, it could not accurately reflect seasonal and latitudinal variations in daylight hours.

USD198536S: This design patent revealed aesthetic aspects of a clock featuring a representation of daylight and darkness. Nonetheless, it did not provide an underlying mechanism or method for automatically updating hour indices according to actual sunrise, sunset, or moonrise data. This invention also did not allow for lunar or other celestial object positioning, because it did not use a half-day/half-night face.

U.S. Pat. No. 2,536,237A: This invention introduced a clock with separate day/night indications, but it did not dynamically move or redistribute hour markers to account for the shifting lengths of day and night, nor did it incorporate an true moonrise/moonset display. Like previous references, it effectively anchored times to a standardized assumption (e.g., daytime hours locked to a fixed portion of the dial from 6:00 am to 6:00 pm).

### Historical Clocks and Related Apparatus

Historically, some mechanical or partially mechanical devices (e.g., “astronomical clocks” in towers, or wadokei from Edo-period Japan) offered seasonal or day-length adjustments. However, these primarily relied on intricate gear systems unique to fixed locales and seasons, with limited or no real-time recalculation for continuous location-based ephemeris data.

Monastic timekeeping, sundials, and even more recent day/night clock attempts did not unify an entire 24-hour cycle, actual sunrise/sunset arcs, moonrise/moonset, and standard civil hours on one dial with real-time updates.

### Modern Day/Night Apps and Widgets

Some mobile applications or widgets provide separate displays or lists of sunrise/sunset times, but they do not incorporate a single 360° dial where hour indices are re-spaced in real time or near real-time, or on location changes to match the precise length of daylight versus nighttime. Nor do they seamlessly integrate moon data so that observers can immediately determine whether the moon is above or below the horizon, and its general position overhead from a rise proximate to the east to a set in proximate to the west.

### Limitations and Gaps in Prior Art

In general, the aforementioned references did not dynamically unify standard time, solar cycles, and lunar cycles on a single dial in real time or near-real time.

They typically lacked an algorithmic approach that (i) anchors an eastern sunrise at the left-side of the clock, at ^{˜}270° and western sunset at the right side of the clock, at ^{˜}90° in a purely digital environment, (ii) proportionally re-distributes hour indices for actual day/night durations, and (iii) accommodates user-selected geographic locations or polar conditions where the sun may not rise or set for extended periods.

Previous art did not present a solution that displays an immediately readable fraction of remaining daylight or night, nor did they automatically handle both daily and seasonal variations on a per-location basis.

In contrast, the present invention offers a purely digital, location-independent solution that recalculates sun and moon arcs every day (or on demand), placing sunrise and sunset as cardinal points on a 360° clock face while distributing hour indices in accordance with each day's actual day/night lengths. This approach bridges known limitations in prior mechanical and partially static digital solutions, improving upon references such as U.S. Pat. No. 1,807,497A, USD198536, and U.S. Pat. No. 2,536,237A by enabling immediate, intuitive reading of both solar and lunar positions alongside conventional civil time.

### FIELD OF THE INVENTION

The present invention relates generally to digital timekeeping integrated with astronomical data, and more particularly to a method of displaying solar position, lunar position, and conventional 24-hour time on a single 360° clockface. The invention ensures immediate readability of whether the sun or moon is above the horizon, how many hours remain until the next sunrise or sunset, and how these events map onto standard hours—for any selected geographic location.

### BACKGROUND OF THE INVENTION

Humanity's quest to measure, interpret, and respect the flow of time has been both technical and cultural since antiquity. Early civilizations forged direct links between daily life and celestial rhythms, treating each hour not merely as a uniform interval but as a reflection of the sun's path or the moon's phase.

### 1. Historical Intersection of Astronomy & Horology

### Ancient Origins

The earliest known timekeeping practices often relied on the sun's motion:

Mesopotamian water clocks (clepsydras) carefully controlled water flows and dripped away hours at night when sundials were ineffective, laying a foundation for nighttime measurement.

Egyptian merkhets aligned with the North Star, capturing cosmic guidance even after sundown.

Polynesian navigators seamlessly read solar arcs and lunar cycles across open seas, trusting an intimate synergy of night skies and ocean currents.

### Medieval & Renaissance Innovations

In Europe, monastic bells rhythmically marked canonical hours, knitting spiritual devotion with the pulse of daily tasks.

The Tower of the Winds in Athens, a monument featuring sundials, wind vanes, and a water clock, showcased how entire communities once shaped their schedules by direct reference to celestial cues.

### Japanese Wadokei (Edo Period)

Among the most refined mechanical adaptations were the wadokei, which showcased adjustable hour indices matching each season's changing day lengths. These marvels embodied the principle that timekeeping should mirror nature's progression—a concept often lost in standard modern clocks.

Despite centuries of refining mechanical dials and 24-hour formats, modern timekeeping typically drifts away from real sunrise/sunset variations, rooting daily schedules in a static representation. Day and night get split evenly, even though actual daylight deviates substantially by latitude and season.

### 2. Limitations of Conventional Day/Night Clocks

Several attempts to represent day and night on a single clock face appear in prior patents. For instance:

U.S. Pat. No. 1,807,497A, USD198536, U.S. Pat. No. 2,536,237A each strove to depict day/night cycles with partially or wholly divided dials. However, these references:
1. Generally anchored sunrise at a fixed hour (e.g., 6 AM) and sunset at another (6 PM), disregarding actual local shifts in sunrise or sunset times.
2. Lacked dynamic hour indices that could expand for a longer summer day or contract for a shorter winter day.
3. Did not integrate moonrise/moonset or lunar phases for a holistic view of celestial events or positioning on one dial.
4. Offered no practical means to adapt automatically to different latitudes or allow real-time location selection.

Additionally, mechanical gear trains crafted in older day/night clocks were often unique to a single locale or season, failing to handle continuous variations or user-adjustable positions. This approach remained firmly in static territory.

### 3. Modern Gaps: Digital but Disconnected

Contemporary smartphone apps or widgets may list sunrise/sunset times numerically, yet they typically do so separately from standard time displays. The user must mentally link “sunset at 8:13 PM” with their daily schedule, losing the direct visual sense of how far into daylight or nighttime they might be.

Further, moon data—moonrise, moonset, illuminated fraction, overhead position—frequently resides in a separate module or app, making alignment between the sun's arc, the moon's phases, and civil hours a scattered pursuit. Few solutions unify these multiple celestial elements onto a single, comprehensive 360° dial that highlights standard hour markers, day/night arcs, and real-time solar or lunar positions.

### 4. Need for a Unified Celestial Clock

Given humankind's enduring desire to visually integrate daily schedules with celestial rhythms, an algorithmic approach that recalculates the position of the sun and moon for any chosen latitude—anchoring sunrise and sunset (and optionally moonrise/moonset) to cardinal angles on a 24-hour dial—becomes both timely and practical. This invention was conceived to:

### 1. Display Day & Night Dynamically

Re-space hour indices every day according to actual sunrise/sunset times, so if a location experiences 15 hours of daylight and 9 hours of night, the top half of the dial contains 15 hour segments, the bottom half contains 9—instantly showing how many daylight hours remain.

### 2. Reflect Lunar Cycles & Religious Observances

Integrate a moon-hand that anchors the eastern moonrise at left, or 270° and a western moonset at right, or 90°—mirroring the sun's logic. This becomes critical for groups whose rituals begin at moonrise or moonset, or who rely on lunar phases (e.g., certain Islamic, Jewish, or cultural festivities).

### 3. Adapt to Extreme Latitudes

Depict polar conditions (e.g., total daylight in Arctic summer or total night in Arctic winter) by confining all 24 hour indices to the top or bottom semicircle.

Such a display clarifies, at a glance, that the sun (or moon) does not cross the horizon on a given day.

### 4. Offer Real-Time & Multi-Location Versatility

A purely digital implementation can instantly recast the clock for any user-selected city or coordinate, benefiting travelers, remote event organizers, or those curious about conditions elsewhere.

### 5. Bridging Ancient Wisdom and Modern Demand

In reintroducing actual solar and lunar arcs into the user's daily schedule, this invention echoes the spirit of Egyptian merkhets and Japanese wadokei, each of which recognized the day as a dynamic rather than static measure. But instead of mechanical gears or intricate local calibrations, the present approach harnesses real-time ephemeris calculations in a wholly digital environment. Whether for practical scheduling (photographers catching golden hour), religious tasks (fasting and prayer times), or simple curiosity (is the moon visible right now?, or how many hours remain until sunset?), the invention stands as a holistic solution that merges standard timekeeping with an immediate, visually rich link to the sky.

In sum, a next-generation timekeeping device that seamlessly displays actual sunrise/sunset arcs, moonrise/moonset arcs, and standard hours in one dial addresses a fundamental human need to see daily life within the broader cosmic rhythm. This bridging of ancient longing for celestial alignment with modern digital convenience is the core impetus driving the present invention.

### SUMMARY OF THE INVENTION

The present invention provides a digital, software-based method for displaying local and astronomical time in an intuitive, single-view 360° clockface that unifies standard civil hours, sunrise/sunset events, moonrise/moonset events, and—optionally—religious or cultural observances keyed to these celestial events. By anchoring sunrise and moonrise at 270° (the left boundary) and sunset and moonset at 90° (the right boundary) of the circular dial, the invention splits the clockface into an upper semicircle for above the horizon and a lower semicircle for below the horizon. Crucially, the total hours represented by indices in each semicircle reflect the actual length of day or night, enabling immediate at-a-glance awareness of how many hours remain until the next sunrise or sunset—and whether the moon is currently above or below the horizon.

### 1. Digital 360° Clockface With Anchored Sunrise & Sunset

The system assigns sunrise to exactly 270° on the dial, designating the left boundary of the above horizon/day arc, and sunset to exactly 90° on the dial, designating the right boundary of the above horizon/day arc. This ensures that the upper half of the circle (270° clockwise through 90°) visually corresponds to what is visible above the horizon/daytime, while the lower half (90° clockwise through 270°) represents what is visible below the horizon/nighttime. If a user's specific geographic location experiences, for example, a 15-hour day, then the upper 180° arc will be subdivided into 15 hour segments, and the remaining 9 hours (making 24 in total) occupy the lower 180° arc.

### 2. Dynamically Distributed Hour and Sub-Hour Indices

Instead of fixing hourly markings at a constant 15° spacing (as in conventional 24-hour clocks), the invention dynamically adjusts the spacing of hour indices. On days with extended daylight, more hour indices cluster in the top half, and fewer appear in the bottom half, reflecting shorter nighttime hours. Conversely, in winter or at higher latitudes, the bottom half might contain many hour indices (for a longer night) and fewer in the top arc. This algorithmic re-spacing ensures the user sees, in a single glance, the fraction of the day completed and how many hours remain of daylight or darkness.

### 3. Sun Indicator for Immediate Daylight Awareness

A sun-hand or sun icon traverses the relevant semicircle during daylight or darkness.

During daylight hours (sun above the horizon), the sun-hand moves from left at 270° (sunrise) clockwise through 0° to right at 90° (sunset) across the top half. The user knows how far along the sun is in its arc, and precisely how many day hours remain.

At night (sun below horizon), the sun-hand continues to rotate clockwise into the bottom half, traveling from 90° at the right through 180° at the bottom around to 270° at the left, indicating time until the next sunrise event.

### Moon Indicator & Lunar Phase Integration

The invention further incorporates a moon-hand anchored similarly: moonrise near 270° and moonset near 90°, with a cycle of approximately 24 hours 50 minutes. If the moon is above the horizon at the current moment (top semicircle), it appears on that arc; if it is below the horizon at night (bottom semicircle), the user instantly sees that.

Optionally, the hand may reflect moon phases, showing the fraction of illumination or the moon's tilt angle. This is especially beneficial for religious, cultural, or photographic uses that rely on precise lunar data.

### Location Selection & Polar Adaptation

Because the invention is purely digital, it seamlessly supports multiple geographic locations:

GPS-based: The user's current latitude and longitude are auto-detected, and the clock recalculates arcs daily (or upon refresh or location change) based on that data.

Manual/Alternate: A user may select a remote city or coordinate, and the system immediately redraws the arcs and hour indices for that locale's ephemeris data (sunrise, sunset, moonrise, moonset, moon phase, moon illumination angle, etc.).

Polar Extremes: If the sun does not rise (Arctic winter) or does not set (Arctic summer), the invention confines all 24 hour indices to the night or day arc, visually depicting continuous daylight or continuous darkness.

### 6. Religious and Cultural Observance Overlays

The system's single-dial approach also accommodates religious or cultural events hinging on solar or lunar thresholds. For instance, if a particular ritual must begin at sunset, the user can readily see the sun-hand approaching sunset, or if a holiday is keyed to the first sighting of the new moon, the moon-hand's approach to moonrise or relevant phase can be monitored. Optional notifications or visual highlights can be generated to remind the user of such upcoming events.

### 7. Eliminating Mechanical Complexity, Operating Purely in Software

The invention's real-time recalculation and daily or hourly updates require no mechanical gearing, no specialized physical linkages, and no stationary, fixed assumptions. Instead, the dial is rendered digitally (e.g., on a smartphone, smartwatch, or computer display), allowing instant updates whenever sunrise/sunset data or user location changes. This purely algorithmic approach sets it apart from past mechanical day/night clocks, which typically anchored day or night to static times.

### 8. Benefits & Advantages

Immediate Readability: Users glance at the dial to see if the sun (or moon) is overhead, how many hours remain until horizon crossing, and what standard hour it currently corresponds to.

Unified View of Day & Night: Unlike typical 24-hour clocks or separate sunrise/sunset schedules, the present invention merges them in one 360° layout that instantly conveys the fraction of completed daylight or night.

User-Selectable Locations: Facilitates planning, travel, remote event coordination, photography shoots, and religious obligations across different geographies.

Polar/Extreme Flexibility: Accurately shows scenarios where no sunrise or no sunset occur.

Historical Heritage: In spirit, it echoes centuries of integrated day/night awareness (e.g., Japanese wadokei, medieval monastic hours, astronomical tower clocks, etc.) but leverages digital ephemeris computations for universal deployment.

Thus, this invention reestablishes the direct relationship between everyday schedules and celestial events—all within a software-driven, location-agnostic format that aligns each user's day and night to the natural arc of the sun and moon. It represents a modern, algorithmic leap forward in day/night clock design, rectifying the limitations of fixed mechanical systems and purely numerical sunrise/sunset lists. By placing all essential data (sun, moon, hour indices, location-based day/night arcs) on a single 360° dial, it offers an immediate, intuitive, and visually compelling representation and unification of time and celestial rhythm.

### BRIEF DESCRIPTION OF DRAWINGS

FIG. 1 (Clock): Presents a diagram of a digitally rendered clockface (day/night) illustrating the unique dial spacing when sunrise occurs near 6:45 AM and sunset near 5:40 PM. The clock face is divided into a lighter half for above the horizon/daytime and a darker half for below the horizon/nighttime. The outer ring is labeled with hour indices (101), depicting the hours of the day in their true relation to day and nighttime. A longer hand (100)—characterized by a line extending past a circle representing the sun—indicates both the current hour in standard civil time and the sun's position in its transit. Another hand, featuring a circle at the end (103), denotes the moon's position before its next rise. Meanwhile, the central hands (102) represent minutes, seconds, and (in a conventional sense) the hour, yet here align with the sun hand for integrated readability. In this illustrated moment, the current time is 1:53 PM and 37 seconds (13:53:37), with the sun past its solar noon and beginning its descent toward a sunset in roughly 4 hours. The moon is below the horizon, but is nearing its rise.

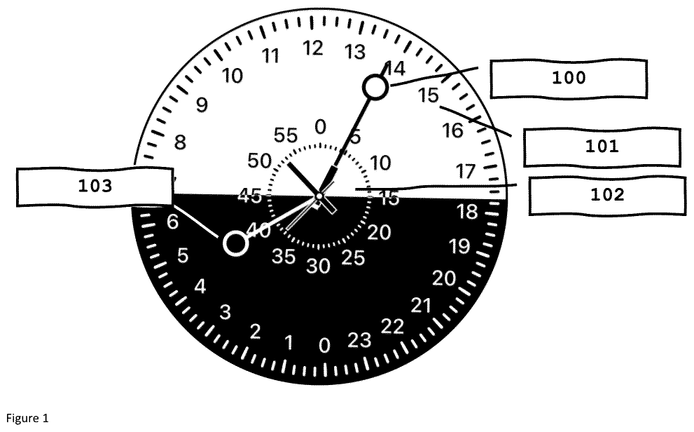

FIG. 2 (Clock on a Winter Day): Depicts the clock under winter conditions, featuring sunrise around 8:35 AM and sunset near 3:15 PM. Again, the outer ring bears the hour indices for the day. A longer hand with a line through a circle (200) merges both the hour of the day and the sun's position in transit from a proximate eastern sunrise to a proximate western sunset. An additional hand, bearing a circle at its tip (201), indicates where the moon lies in its journey from a proximate eastern moonrise to a proximate western moonset before its forthcoming transition below the horizon. The clock's central hands continue to show minutes, seconds, and hours. Illustrated time is 1:07 PM (13:07), with the sun past its solar noon but still above the horizon. This scenario highlights a short winter day, where daylight is noticeably compressed on the clock face, with less than 7 hours of daylight.

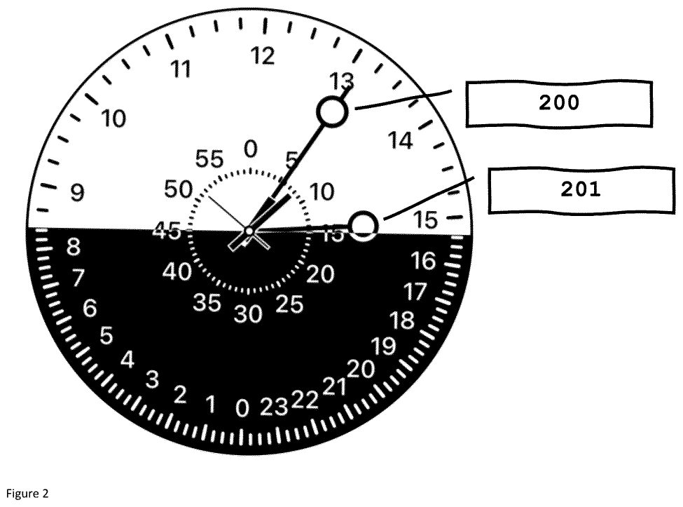

FIG. 3 (Clock on a Summer Day): Showcases the clock design during an extended summer daylight period, with sunrise near 4:15 AM and sunset close to 9:50 PM. The outer ring again includes the hour indices for the day. A longer hand with a line extending past a circle again denotes both the hour in civil time and the sun's position overhead arc. Another hand with a circle at the end follows the moon's location prior to its next rise. The central hands represent conventional minutes, seconds, and hour references, synchronized with the sun hand to reduce confusion between solar transit and standard time. Notably, the current time is 3:54 PM (15:54), reflecting a scenario where the sun remains above the horizon, has past solar noon, and the moon has already set. This figure emphasizes how the clockface accommodates long summer days by dedicating more hour markings to the daytime arc.

FIG. 4 (Flowchart): Illustrates the runtime process of the celestial clock system through a detailed flowchart numbered from 401 to 433. This flowchart outlines the sequence of operations starting from obtaining user inputs, computing celestial events, applying bracketing logic, determining day and night durations, processing time and moon increments, assigning and placing hour markers, rendering the dynamic 360° clockface, and continuously monitoring for updates.

FIG. 5 (Alternate Clock): Presents an alternative clock view that primarily displays the sun indicator (502) and moon indicator (501), simplifying other components for a minimalistic aesthetic. This version might be employed in scenarios where the user desires high emphasis on solar and lunar positions without minute and second labeling.

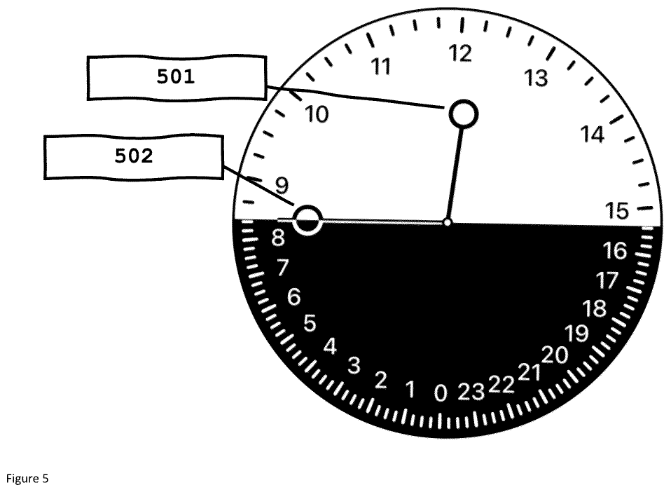

FIG. 6 (Alternate Clock): Offers yet another variant with only the sun and moon indicators, plus a limited set of hour markers. Such minimal hour markers might be beneficial for users who prefer a more streamlined dial while still retaining essential day/night or sun/moon data.

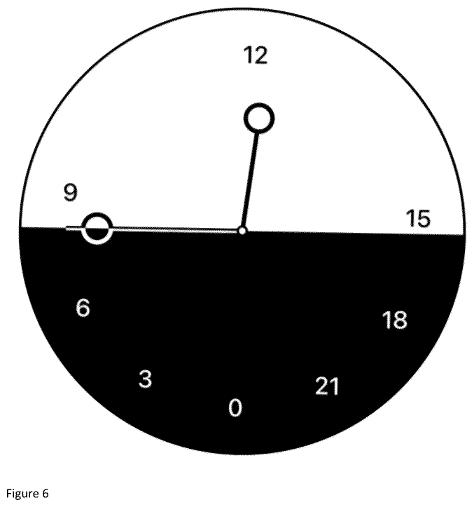

FIG. 7 (Alternate Clock): Illustrates a variation wherein the sun and moon (701) indicator remains central, and a series of circular shapes for 24 hourly indices (702) replace the typical numeric and line markers representing hours. This design choice underscores the flexibility of the invention's underlying method—retaining the crucial separation of day/night arcs, sunrise/sunset anchors, and integrated solar-lunar depiction—while allowing significant stylistic freedom in how indices are represented.

FIG. 8 (Location Picker): Illustrates the Location Picker interface of the digital celestial clock system. This component presents users with a predefined list of geographic locations from which they can select their desired location. The interface includes a scrollable list of major cities and regions, allowing users to effortlessly choose a location that suits their needs, as well as their current location.

FIG. 9 (Polar Night with Waning Crescent Moon): Illustrates the celestial clockface operating in a polar region experiencing 24 hours of nighttime. In this scenario, the entirety of hourly indices are dedicated to the nighttime arc, accurately representing continuous darkness without any daylight segments. The moon indicator is depicted in a waning crescent phase, positioned to signify its visibility above the horizon during the current moment.

### DETAILED DESCRIPTION OF THE INVENTION

This invention provides a purely digital system for displaying and integrating solar (sunrise/sunset) and lunar (moonrise/moonset) positioning with standard civil time on a 360° clockface, ensuring that users can immediately discern whether the sun or moon is overhead, how many hours remain until the next sunrise or sunset, and which hours of the day belong to daytime or nighttime. Unlike prior art that fixes day/night boundaries at approximate times (e.g., 6:00 a.m. and 6:00 p.m.) or relies on mechanical gearing, this invention calculates and updates such boundaries dynamically, using real-world ephemeris data and wholly software-based coordinate transformations.

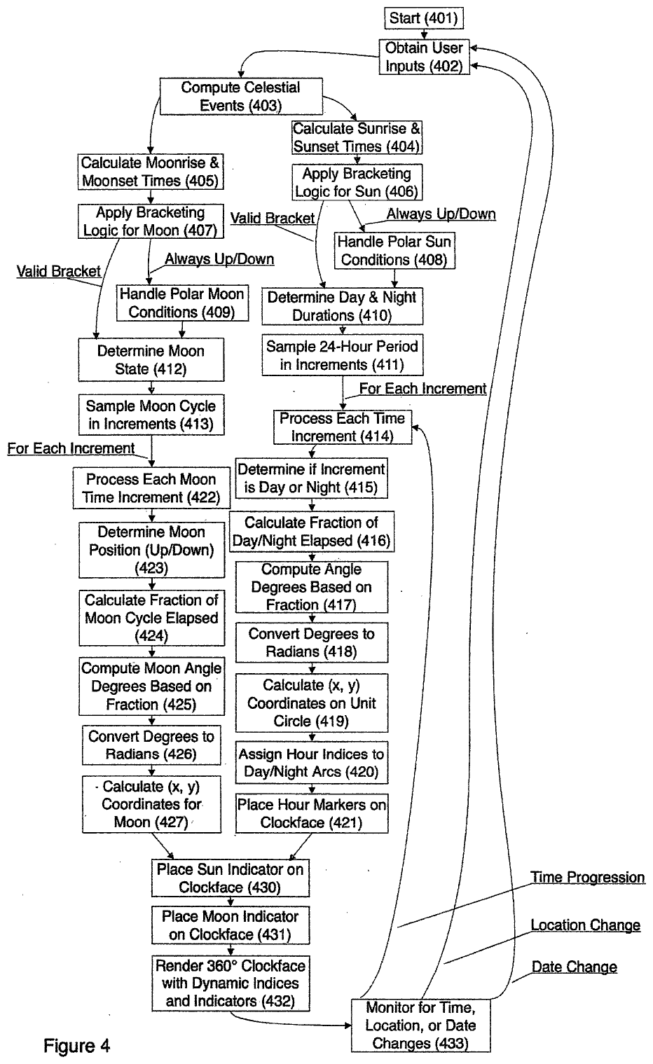

As illustrated in FIG. 4, step (401), the runtime process encompasses obtaining user inputs, computing celestial events, applying bracketing logic, determining day and night durations, processing time and moon increments, assigning and placing hour markers, rendering the dynamic clockface, and continuously monitoring for updates.

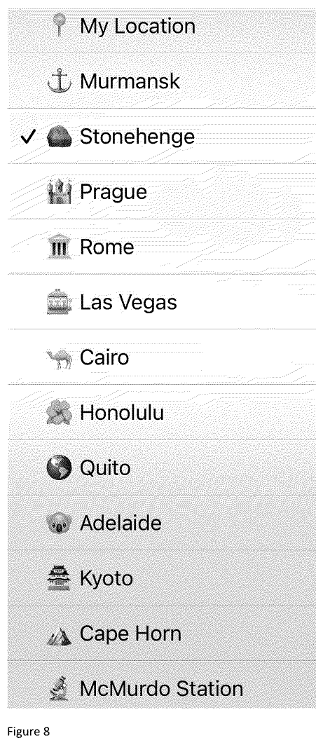

Step (402) specifically involves the optional Location Picker (FIG. 8), a user interface component that enables users to select their desired location, if the GPS-detected location is not desired. This location picker is vital for tailoring celestial event calculations to the user's precise location or an alternate location of interest, ensuring the accuracy of sunrise, sunset, moonrise, and moonset times.

Steps (406) and (407) apply bracketing logic to ensure that the calculated sunrise and sunset times accurately encompass the current date and time, while also handling special scenarios like polar regions where the sun or moon may remain continuously above or below the horizon. Step (410) determines the total durations of day and night based on the bracketing results.

Steps (411) to (421) involve sampling the 24-hour period in discrete increments, processing each time increment to calculate the corresponding angles and coordinates, assigning hour and minute indices (such as 15-minute intervals) proportionally to the day and night arcs, and placing these hour markers on the clockface. Steps (422) to (427) handle the processing of moon time increments, determining the moon's position and calculating its placement on the clockface.

Steps (430) and (431) focus on positioning the sun and moon indicators based on their calculated coordinates, ensuring accurate and real-time representation of their positions. Step (432) culminates in rendering the comprehensive 360° clockface, integrating all dynamic indices and celestial indicators. Finally, step (433) monitors for any changes in time progression, user location, or date, triggering updates to maintain the clockface's accuracy and relevance.

In the exemplary embodiment, 0° is situated at the top of the dial, 90° at the right, 180° at the bottom, and 270° at the left. Under this orientation, sunrise is anchored near 270° (left boundary) and sunset near 90° (right boundary). Consequently, the upper semicircle (spanning from 270° through 0° to 90°) represents daytime, while the lower semicircle (spanning from 90° through 180° to 270°) represents nighttime. These anchors align with the daily movement of the sun from left to right across the sky in many latitudes, although the invention can be adapted to other orientations or directional references without departing from its essential method.

To implement this approach, the system first acquires key input data, including the user's location (via GPS or manual entry), the local or desired time zone, and the current or target date. The invention then retrieves and computes sunrise and sunset times (and optionally moonrise and moonset times) for that date and location. Here, the concept of bracketing ensures that the sunrise and sunset returned genuinely contain the user's current date/time. Refer to step (403) for a detailed flowchart of this process. This is achieved with functions such as bracketedSunTimes(coordinates:currentDate:timeZone:height:), which inspects potential sunrise/sunset pairs around midnight boundaries and, if necessary, shifts them by ±1 day or forcibly sets them to reflect always up or always down conditions in polar scenarios. Thus, if the sun never crosses the horizon (e.g., Arctic summer or winter), the invention automatically flags “alwaysUp” or “alwaysDown,” ensuring the entire dial can visually represent continuous daylight or continuous darkness.

### A. Purpose and Functionality of bracketedSunTimes

The bracketedSunTimes function is a pivotal component designed to accurately determine sunrise and sunset times that bracket the current date and time for a specified geographic location. Bracketing ensures that the current time falls between a valid pair of sunrise and sunset times, which is essential for correctly positioning the sun indicator on the clockface. Additionally, the function handles special scenarios such as polar regions where the sun may remain continuously above or below the horizon.

### B. Step-by-Step Process of bracketedSunTimes Function

First, the function receives input parameters comprising geographic coordinates (latitude and longitude), the current date and time, the relevant time zone, and the elevation above sea level. These inputs are essential for precise astronomical calculations.

Then, the function computes initial sunrise and sunset times using an astronomical library (e.g., Astronomical Algorithms, Jean Meeus). This computation considers the provided coordinates, date, time zone, and elevation to determine the baseline sunrise (rise) and sunset (set) times for the current day.

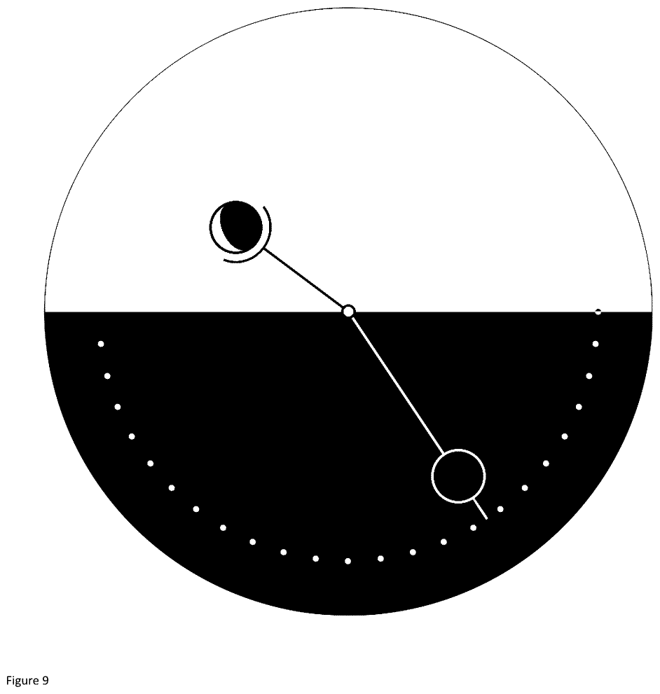

Next, the function assesses whether the calculated sunrise and sunset times fall within a standard 24-hour period. This assessment involves calculating the time intervals between sunrise and sunset, nadir (the point when the sun is at its lowest during the day), and sunrise to noon. If any of these intervals exceed 24 hours, it indicates polar conditions where the sun does not set (Midnight Sun) or does not rise (Polar Night), as seen in FIG. 9.

If polar conditions are detected, the function adjusts the sunrise and sunset times accordingly:

For Continuous Daylight (“alwaysUp”): The function sets sunrise to 00:00:00 (midnight) and sunset to 24:00:00 (the following midnight), effectively allocating the entire 24-hour period to daylight.

For Continuous Darkness (“alwaysDown”): Similarly, the function sets sunset to 00:00:00 and sunrise to 24:00:00, allocating the entire period to nighttime.

Otherwise, if polar conditions are not present, the function verifies whether the current time falls between the computed sunrise and sunset times. This verification ensures that the sunrise and sunset times bracket the current date and time.

If the current time is within the bracketed interval, the function returns the computed sunrise and sunset times as valid bracketed times. This outcome ensures that the sun can be accurately positioned on the clockface within the daytime arc.

If the current time does not fall within the initial bracket, the function adjusts the sunrise and sunset times to create a valid bracket. This adjustment involves:

Adding a Day: If the current time is after sunset but before the next day's sunrise, the function increments the sunrise time by one day to ensure proper bracketing.

Subtracting a Day: Conversely, if the current time is before sunrise, the function subtracts a day from the sunset time to align the bracket correctly.

After adjustment, the function revalidates the bracketing. If the current time now falls within the newly adjusted sunrise and sunset times, the function returns these times. This recursive adjustment ensures robustness against edge cases, such as cross-midnight scenarios.

Having obtained valid rise/set pairs, the system uses coordinate mapping to place the sun or moon on a unit circle. A critical function named getBodyCoordinates(rise:set:currentDate:timeZone:) compares the current time to the bracketed rise and set times. If the user's currentDate lies between sunrise and sunset, the invention considers the sun (or moon, comparing moonrise and moonset) to be “up,” mapping that fraction of daytime to an angle within the top semicircle (270°→90°). Conversely, if currentDate falls between sunset and the next sunrise, the body is “down,” and its angle is placed in the bottom semicircle (90°→270°). Mathematically, the fraction of elapsed day or night is used to compute a degree value. Converting degrees to radians, the function derives (x, y)=(cos(θ), sin(θ)), returning a normalized coordinate in a unit circle representation. Subsequent steps scale this point by the clock's radius to yield the final position for the sun-hand or moon-hand in the graphical user interface. Refer to step (419) for the coordinate calculation process.

### A. Purpose and Functionality of getBodyCoordinates Function

The getBodyCoordinates(rise:set:currentDate:timeZone:) function is essential for accurately positioning celestial bodies (sun or moon) on a 360° clockface based on real-time astronomical data. Its primary purpose is to determine the precise location of the sun or moon relative to the user's current time and geographic location, ensuring that the graphical representation on the clockface accurately reflects the celestial body's position above or below the horizon.

### B. Step-by-Step Process of getBodyCoordinates Function

First, the function receives input parameters including: rise—the sunrise or moonrise time as a Date object, set—the sunset or moonset time as a Date object, currentDate—the current date and time as a Date object, and timeZone—the location's local time zone as a TimeZone object.

These inputs are crucial for determining whether the celestial body is currently above or below the horizon.

Then, the function determines the celestial body's state (either “up” or “down”) by comparing currentDate with the celestial body's rise and set times: If currentDate is between rise and set, the celestial body is considered “up”. If currentDate is between set and the next day's rise, the celestial body is considered “down”.

This comparison ensures that the function accurately reflects the celestial body's current position relative to the horizon.

Next, the function calculates the fraction of elapsed time within the current state (“up” or “down”). These fractions represent how much of the above-horizon or below-horizon period has elapsed, respectively:

For the “up” state: fractionOfDay=(currentDate.timeIntervalSince(rise))/(set.timeIntervalSince(rise))

For the “down” state: fractionOfNight=(currentDate.timeIntervalSince(set))/(rise.timeIntervalSince(set))

Then, the function computes the corresponding angle on the unit circle based on the elapsed fraction:

For the “up” state: angleDegrees=180°+(fractionOfDay*180°). This maps the elapsed daytime fraction to an angle between 180° and 360° (270°→90° on the clockface).

For the “down” state: angleDegrees=(fractionOfNight*180°). This maps the elapsed nighttime fraction to an angle between 0° and 180° (90°→270° on the clockface).

Next, the function converts the angle from degrees to radians: angleRadians=angleDegrees*(π/180). This conversion is necessary for applying trigonometric functions that operate in radians.

Then, the function derives the normalized (x, y) coordinates on the unit circle using the cosine and sine of the angle: x=cos(angleRadians) and y=sin(angleRadians). These coordinates represent the position of the celestial body on a unit circle, where the radius is 1.

Finally, the function scales the (x, y) coordinates by the clock's radius to determine the final position on the graphical user interface: finalX=clockCenterX+(x*clockRadius) and finalY=clockCenterY+(y*clockRadius)

Here, clockCenterX and clockCenterY represent the center point of the clockface, and clockRadius is the radius of the clock's circular display. The scaled coordinates (finalX, finalY) position the sun-hand or moon-hand accurately on the clockface.

### C. Mathematical Basis and Coordinate Mapping

The mathematical foundation for the getBodyCoordinates function relies on unit circle trigonometry. By mapping the fraction of elapsed day or night to an angle, and subsequently to (x, y) coordinates, the function translates temporal data into spatial positioning on the clockface.

To reflect the variable lengths of day and night, the invention re-spaces hour indices for each 24-hour cycle. Traditional 24-hour clocks often divide the circle equally into 24 increments (15° each), but here, the top half from 270° to 90° is subdivided according to the actual day length, and the bottom half from 90° to 270° according to the actual night length. For instance, if the day lasts 14 hours and the night 10, the top semicircle might contain 14 hour ticks, and the bottom semicircle 10. This dynamic distribution is carried out by sampling the 24-hour period in discrete increments—hourly or more refined—and invoking the same coordinate function (getBodyCoordinates) to determine which arc (day or night) an hour belongs to, and its position along that arc. Refer to steps (411) to (421) for a visual representation of this dynamic spacing process.

### A. Purpose and Functionality of Dynamic Hour Index Spacing

The dynamic spacing of hour indices is designed to visually represent the actual duration of daylight and nighttime within a 24-hour cycle. Unlike traditional clocks that uniformly distribute hour markers, this invention allocates hour markers proportionally based on the real-world lengths of day and night. This approach enhances the clock's ability to provide intuitive visual cues about the remaining daylight or darkness, thereby improving user awareness and interaction with natural time cycles.

### B. Step-by-Step Process of Re-Spacing Hour Indices

First, the system determines the lengths of day and night for the current 24-hour cycle. This determination is based on previously calculated sunrise and sunset times obtained through the bracketedSunTimes function. Refer to step (410) for the calculation of day and night durations.

Then, the system subdivides the clockface's top and bottom semicircles according to the determined lengths of day and night: The top semicircle (270°→90°) is allocated to daylight hours. The bottom semicircle (90°→270°) is allocated to nighttime hours.

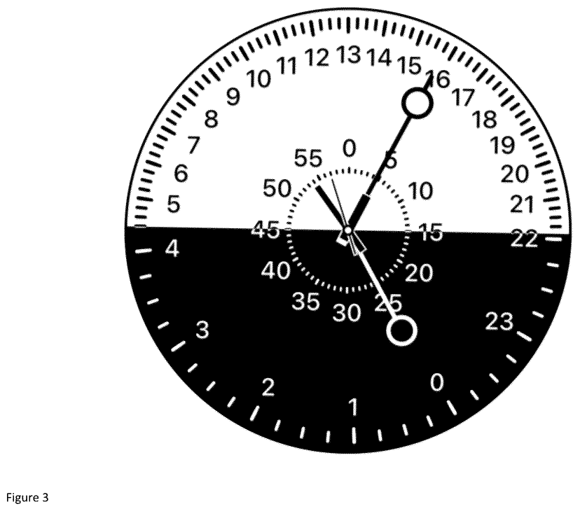

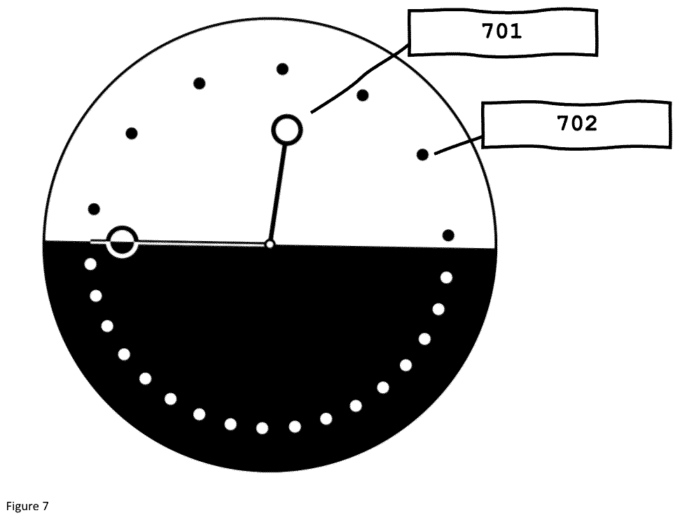

Next, the system samples the 24-hour period in discrete increments. These increments can be hourly or more refined (e.g., every hour as in FIG. 7, or 15 minutes as in FIG. 3) to achieve the desired precision in hour marker placement. Refer to step (411) for the sampling process.

Then, for each sampled increment, the system invokes the getBodyCoordinates function to: a) Determine the arc (day or night) to which the hour belongs. b) Calculate the position of the hour marker along the corresponding arc based on the elapsed fraction of day or night. Refer to steps (414) to (420) for detailed processing of each increment.

Finally, the system renders the hour markers on the clockface by placing them at the calculated positions within the appropriate semicircle, ensuring that the distribution accurately reflects the actual lengths of day and night. See step (421) for the placement of hour markers.

### C. Mathematical Basis for Dynamic Spacing

The mathematical foundation for dynamic hour spacing leverages proportional allocation based on the actual lengths of day and night. The process ensures that each hour marker's angular position accurately reflects its temporal significance within the daylight or nighttime period.

### Fractional Calculations:

Day Fraction: (Fraction of Day)=(Elapsed Daytime)/(Total Daytime Length)

Night Fraction: (Fraction of Night)=(Elapsed Nighttime)/(Total Night Length)

### Angular Positioning:

Daytime Arc (Top Semicircle): θ_{day}=270°+(Fraction of Day*180°)

Nighttime Arc (Bottom Semicircle): θ_{night}=90°+(Fraction of Night*180°)

Conversion to Radians: θ_{radians}=θ_{degrees}*(π/180)

### Coordinate Mapping:

x=cos(θ_{radians})

y=sin(θ_{radians})

These normalized coordinates are then scaled by the clock's radius to determine the final position of each hour marker on the clockface.

This proportional approach ensures that:

Longer Daylight Periods: More hour markers are placed within the top semicircle, reflecting extended daylight.

Shorter Daylight Periods: Fewer hour markers are placed within the top semicircle, with more markers allocated to the bottom semicircle to represent extended nighttime.

When displaying the sun and moon simultaneously, the same bracketed ephemeral logic is applied to each body. That is, bracketedSunTimes is used for sunrise/sunset, and bracketedMoonTimes for moonrise/moonset, ensuring each body's actual overhead intervals are correctly identified—even if the moon is above the horizon during daytime, or if a cross-midnight scenario occurs. As detailed in steps (422) to (427), by calling getBodyCoordinates for both solar and lunar times, two distinct hands or icons appear on the 360° dial: one representing the sun, one representing the moon. Optional phase calculations for the moon can overlay a crescent (FIG. 9) or other accurate phase of the moon, supporting religious events, photographic planning, or general astronomical enthusiasm.

Daily or more frequent recalculations occur whenever the user changes location, updates the date/time, or the device triggers a refresh. By repeating the bracket approach, the system adjusts seamlessly to polar extremes where day and night might not happen on the same calendar day, or to a user requesting ephemeral data for remote latitudes. Specifically, if ephemeral computations discover “alwaysUp” or “alwaysDown,” sunrise and sunset are artificially set at 00:00 and 24:00 or vice versa, causing the upper or lower semicircle to dominate, visually reinforcing perpetual sunlight or darkness. The moon's data follows the same principle, with “alwaysUp” or “alwaysDown” flagged if local conditions keep the moon above or below the horizon for extended cycles.

At runtime, a “center point” in the UI (0,0) marks the clock's origin, from which the sun or moon-hand is drawn to (x, y) according to the angles computed in getBodyCoordinates. Refer to steps (430) and (431) for the placement of the sun and moon indicators. The user sees a single integrated clockface, typically parted into a lighter top half for day and a darker bottom half for night, with numeric or minimal tick marks reflecting day and night hours. If day is extended, the upper half displays more hour increments; if night is extended, the lower half does so.

This purely algorithmic method departs significantly from older mechanical designs, which often presumed sunrise was static or at best used complex gear-ratio linkages that could not handle random location changes or extreme latitudes. By contrast, the present invention's “bracketed ephemeral” approach and coordinate logic can handle infinite latitudinal variations, cross-midnight shifts, multiple day offsets, and real-time user reconfiguration with minimal overhead. As outlined in steps (432) and (433), it further permits layering religious or cultural alerts (for instance, if a user desires notifications at sunset for daily rituals) or advanced features such as partial “blue hour” warnings. Additionally, the entire system is easily ported to different programming languages or platforms, as the essential steps—(i) bracket times, (ii) map them to arcs (top or bottom) via angles, (iii) draw hour indices in proportion to day/night durations—remain consistent.

In sum, the invention reconstructs the fundamental link between civil schedules and celestial events by anchoring sunrise at 270° and sunset at 90°, dividing the 360° dial into an upper daytime arc and a lower nighttime arc, and using ephemeral bracket logic to place the sun or moon overhead or under the horizon. The user thereby perceives, at a glance, which hours remain until day transitions to night or vice versa, or how a summer day compresses many hours into the top region, if the moon may be seen overhead at the current moment, or other intuitive observations. By combining these steps (data retrieval, bracket logic, coordinate mapping, scaled hour indices, and final graphical rendering), the invention delivers a thorough, real-time depiction of solar and lunar reality within a single, visually intuitive clockface—free from the static constraints and approximations of traditional mechanical or partially digital day/night clocks.

1. A digital timekeeping system for displaying standard civil time alongside dynamically calculated sunrise and sunset, comprising:
a. A location determination module configured to obtain a geographic location of a user and a current date and time associated therewith;
b. A celestial computation module configured to:
i. retrieve or compute sunrise and sunset times for said geographic location and date,
ii. apply an ephemeral “bracketing” logic that ensures said sunrise and sunset times correspond to an interval containing said current date and time, including scenarios where said sun does not rise or set over a given 24-hour period;
c. A graphical user interface rendering a 360° circular clockface, in which:
i. 0° is located at a top position,
ii. 90° is located at a right boundary,
iii. 180° is located at a bottom boundary,
iv. 270° is located at a left boundary;
d. A day/night allocation module that:
i. anchors sunrise to 270° and sunset to 90° within said 360° circular clockface,
ii. designates a daytime arc along an upper half of said clockface from 270° through 0° to 90°, and a nighttime arc along a lower half of said clockface from 90° through 180° to 270°,
e. A dynamic hour-index spacing module that:
i. assigns hour indices in proportion to the actual computed duration of daytime vs. nighttime,
ii. places hour marks corresponding to daytime hours in said daytime arc, and hour marks corresponding to nighttime hours in said nighttime arc,
f. A sun indicator that:
i. continuously traverses said entire 360° clockface as time progresses,
ii. is displayed on said upper half when ephemeral data indicates the sun is above the horizon, and is displayed on said lower half when ephemeral data indicates the sun is below the horizon,
g. wherein the system merges standard civil hour labeling with a dynamic ephemeral alignment of sunrise, sunset, and day/night arcs, thereby enabling immediate identification of how many daylight or nighttime hours remain in relation to said current date and time.

2. The system of claim 1, wherein said celestial computation module further calculates a moonrise and moonset for said geographic location and date using an analogous bracketing logic, and said graphical user interface displays a moon indicator that also traverses the 360° clockface, appearing on the top half if the moon is above the horizon and on the bottom half if the moon is below the horizon.

3. The system of claim 2, wherein said celestial computation module determines an illumination phase of the moon and adjusts the appearance of said moon indicator to reflect said illumination phase.

4. The system of claim 1, wherein, upon detecting that the sun remains continuously above the horizon (“always up”) or continuously below the horizon (“always down”), the system artificially sets respective sunrise or sunset times so that the entire 360° clockface appears as exclusively daytime or nighttime for said current date.

5. The system of claim 1, further comprising a user configuration interface allowing a user to manually select a different geographic location, wherein the celestial computation module recalculates sunrise, sunset, and the placement of hour indices on said daytime or nighttime arcs accordingly.

6. The system of claim 1, wherein said dynamic hour-index spacing module subdivides each 24-hour period into hour marks or partial increments and invokes said ephemeral bracketing logic to determine if each increment belongs in the upper day arc or lower night arc, thereby re-spacing the hour indices daily as sunrise/sunset times shift.

7. The system of claim 1, wherein said sun indicator is animated across the entire 360° clockface in real time or near real time, such that a user can observe the sun's positional change continuously.

8. The system of claim 1, wherein said system provides notifications when the sun indicator approaches ^{˜}90° (sunset) or ^{˜}270° (sunrise), facilitating user awareness of impending changes in daylight.

9. The system of claim 2, wherein said moon indicator is likewise animated, and the system provides notifications when the moon indicator nears its respective rise or set angle.

10. The system of claim 1, wherein said system exclusively operates via software-based computations, absent any mechanical gearing or linkages for shifting day/night partitions, thus enabling real-time recalculation of hour indices, sunrise, and sunset angles for any user-selected location and date.

11. A method for displaying time and celestial events on a digital 360° clockface, comprising the steps of:
a. Obtaining a user's geographic location and current date/time,
b. Computing sunrise and sunset times for said date and location via ephemeral bracketing logic, such that said times bound the current date or reflect “always up” or “always down” in polar extremes,
c. Allocating a daytime arc from approximately 270° to 90° on said 360° clockface and a nighttime arc from 90° to 270°,
d. Distributing hour indices proportionately between said arcs according to the computed durations of day and night,
e. Rendering a sun indicator that can revolve around the entire 360° dial, appearing in the upper half when the sun is above the horizon and in the lower half when the sun is below the horizon,
f. Overlaying standard civil hour labels so that a user can instantly perceive how many hours remain in said daytime arc or nighttime arc relative to said current time.

12. The method of claim 11, further comprising computing moonrise and moonset times via an analogous ephemeral bracketing logic and rendering a moon indicator that also traverses the 360° clockface, with its position above or below the horizon indicated by top or bottom placement on said dial.

13. The method of claim 11, wherein, upon detecting no sunrise or no sunset for said date, the method assigns all hour indices to either the daytime arc or nighttime arc, thereby indicating continuous daylight or continuous darkness.

14. The method of claim 11, further comprising animating the sun indicator's movement across the dial in real time or near real time, enabling the user to observe dynamic transitions above and below the horizon.

15. The method of claim 12, further comprising calculating lunar illumination and displaying a partial or full moon graphic in said moon indicator to signify the current phase.

16. The method of claim 11, further comprising enabling user selection of an alternate geographic location or date, wherein the ephemeral logic is re-run and the dial arcs, hour indices, and sun indicator are updated accordingly.

17. A non-transitory computer-readable medium storing program instructions which, when executed by a processor, cause a device to perform the method of claim 11.
